(19) United States
(12) Patent Application Publication
(10) Pub. No.: US 2009/0110458 A1
(43) Pub. Date: Apr. 30, 2009

(54) POST-PROCESSING APPARATUS AND IMAGE FORMING APPARATUS

(75) Inventor: Mahito SATO, Saitama-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/142,557

(22) Filed: Jun. 19, 2008

(30) Foreign Application Priority Data
Oct. 29, 2007 (JP) 2007-280028

(51) Int. Cl. G03G 15/00; B65H 31/00

(52) U.S. Cl. 399/405; 271/207

(57) ABSTRACT

A post-processing apparatus is provided, in which a sheet to be post-processed is substantially vertically dropped in a sequence from a first stage to a second stage, and from the second stage to a third stage, the sheet is temporarily stored in the first stage, a bundle of sheets is post-processed in the second stage, and the sheets are stacked in the third stage, wherein an opening/closing first supporting member is disposed in the first stage, an opening/closing second supporting member and a post-processing unit are disposed in the second stage, a sheet stacking member is disposed in the third stage, and the apparatus includes an integral sheet aligning member which butts against an end portion of the sheet supported by the first supporting member, and end portions of the sheets supported by the second supporting member, and a sheet aligning member moving unit which moves the sheet aligning member.

### CROSS-REFERENCE TO RELATED APPLICATIONS

This application is based on and claims priority under 35 USC 119 from Japanese Patent Application No. 2007-280028 filed on Oct. 29, 2007.

### BACKGROUND

### Technical Field

The present invention relates to a post-processing apparatus and an image forming apparatus.

### SUMMARY

According to an aspect of the invention, there is provided a post-processing apparatus in which a sheet to be post-processed is substantially vertically dropped in a sequence from a first stage to a second stage, and from the second stage to a third stage, the sheet is temporarily stored in the first stage, a bundle of sheets is post-processed in the second stage, and the sheets are stacked in the third stage, wherein an opening/closing first supporting member which, at a closed position, substantially horizontally supports a sheet, and which, at an opened position, is disengaged from the support of the sheet is disposed in the first stage, an opening/closing second supporting member which, at a closed opened position, substantially horizontally supports a sheet, and which, at an opened position, is disengaged from the support of the sheet, and a post-processing unit which post-processes a bundle of sheets supported by the second supporting member are disposed in the second stage, a sheet stacking member on which the bundle of sheets that has been subjected to the post-processing is stacked is disposed in the third stage, and the apparatus comprises an integral sheet aligning member which butts against an end portion of the sheet supported by the first supporting member, and end portions of the sheets supported by the second supporting member, and a sheet aligning member moving unit which moves the sheet aligning member.

### BRIEF DESCRIPTION OF THE DRAWINGS

Exemplary embodiment(s) of the present invention will be described in detail based on the following figures, wherein:

FIG. 1 is a diagram showing an example of the configuration of an image forming apparatus to which the invention is applied;

FIG. 2 is a schematic front view showing an example of the configuration of a post-processing apparatus of an exemplary embodiment of the invention;

FIG. 3 is a schematic side view showing the example of the configuration of the post-processing apparatus of the exemplary embodiment of the invention;

FIG. 4 is a diagram (No. 1) showing an example of the operation of the post-processing apparatus of the exemplary embodiment of the invention;

FIG. 5 is a diagram (No. 2) showing the example of the operation of the post-processing apparatus of the exemplary embodiment of the invention;

FIG. 6 is a diagram (No. 3) showing the example of the operation of the post-processing apparatus of the exemplary embodiment of the invention;

FIG. 7 is a diagram (No. 4) showing the example of the operation of the post-processing apparatus of the exemplary embodiment of the invention;

FIG. 8 is a diagram (No. 5) showing the example of the operation of the post-processing apparatus of the exemplary embodiment of the invention;

FIG. 9 is a diagram (No. 6) showing the example of the operation of the post-processing apparatus of the exemplary embodiment of the invention;

FIG. 10 is a diagram (No. 7) showing the example of the operation of the post-processing apparatus of the exemplary embodiment of the invention;

FIG. 11 is a diagram (No. 1) showing another example of the operation of the post-processing apparatus of the exemplary embodiment of the invention;

FIG. 12 is a diagram (No. 2) showing the other example of the operation of the post-processing apparatus of the exemplary embodiment of the invention; and

FIG. 13 is a diagram showing main portions of a post-processing apparatus of another exemplary embodiment of the invention, wherein 1 denotes post-processing apparatus, 5 denotes buffer arm, 6 denotes compile arm, 7 denotes side tamper, 10 denotes tail tamper, 11 denotes staple, 12 denotes stack tray, 13 denotes sheet, 100 denotes image forming apparatus.

### DETAILED DESCRIPTION

Hereinafter, specific exemplary embodiments of the invention will be described in detail with reference to the drawings.

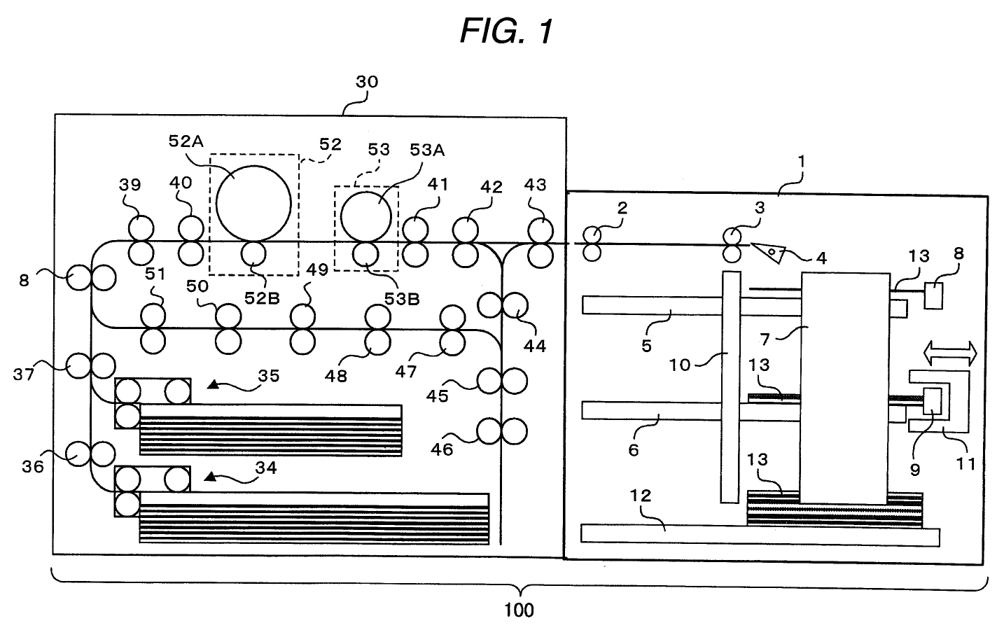

FIG. 1 is a diagram showing an example of the configuration of an image forming apparatus to which the invention is applied. The illustrated image forming apparatus 100 comprises an image forming apparatus main unit 30 and a post-processing apparatus 1. Two sheet supplying devices 34, 35 which are vertically arranged in two respective stages are incorporated in the image forming apparatus main unit 30. Each of the sheet supplying devices 34, 35 is configured by: a sheet housing portion which has a tray-like shape, a cassette-like shape, a box-like shape, or the like; and a sheet feeding roll which feeds one by one sheets housed in the sheet housing portion in the sequence beginning with the uppermost sheet.

In the image forming apparatus main unit 30, a sheet conveying path for conveying sheets fed from the sheet supplying devices 34, 35. The sheet conveying path is formed by conveying path members which are not shown. Plural conveying rolls (roll pairs) 36 to 51 are disposed at predetermined intervals on the sheet conveying path.

On the sheet conveying path, between the conveying rolls 40, 41, an image transferring device 52 and an image fixing device 53 are disposed as functioning portions for forming an image on a sheet. The image transferring device 52 transfers an image (toner image) onto a sheet which is conveyed along the sheet conveying path. The image transferring device 52 has a photosensitive drum 52A and transferring roll 52B which are opposed to each other across the sheet conveying path. Although not illustrated, the image transferring device 52 has: a charging device which charges the photosensitive drum 52A; an image writing device which, by means of a laser beam, exposes and scans the surface of the photosensitive drum 52A that is charged to a predetermined potential by the charging device, thereby writing an electrostatic latent image; and a developing device which develops the electrostatic latent image written by the image writing device, by using, for example, a two-component developer consisting of a toner and a carrier.

The photosensitive drum 52A and the transferring roll 52B are placed in a state where they are contacted with each other at a predetermined pressure. When an image is to be formed on a sheet, the photosensitive drum 52A is rotated at a constant speed in a counterclockwise direction in the figure. While rotating by being driven by the photosensitive drum 52A, the transferring roll 52B cooperates with the photosensitive drum 52A to nip the sheet therebetween, and applies charges which are opposite in polarity to the toner, to the sheet, whereby a toner image on he photosensitive drum 52A is transferred onto the sheet.

The image fixing device 53 fixes the image (toner image) to the sheet which is conveyed along the sheet conveying path. The image fixing device 53 comprises: a heating roll 53A which is heated to a predetermined temperature (fixing temperature) by a heater or the like; and a pressure roller 53B which is contacted with the heating roll 53A at a predetermined pressure.

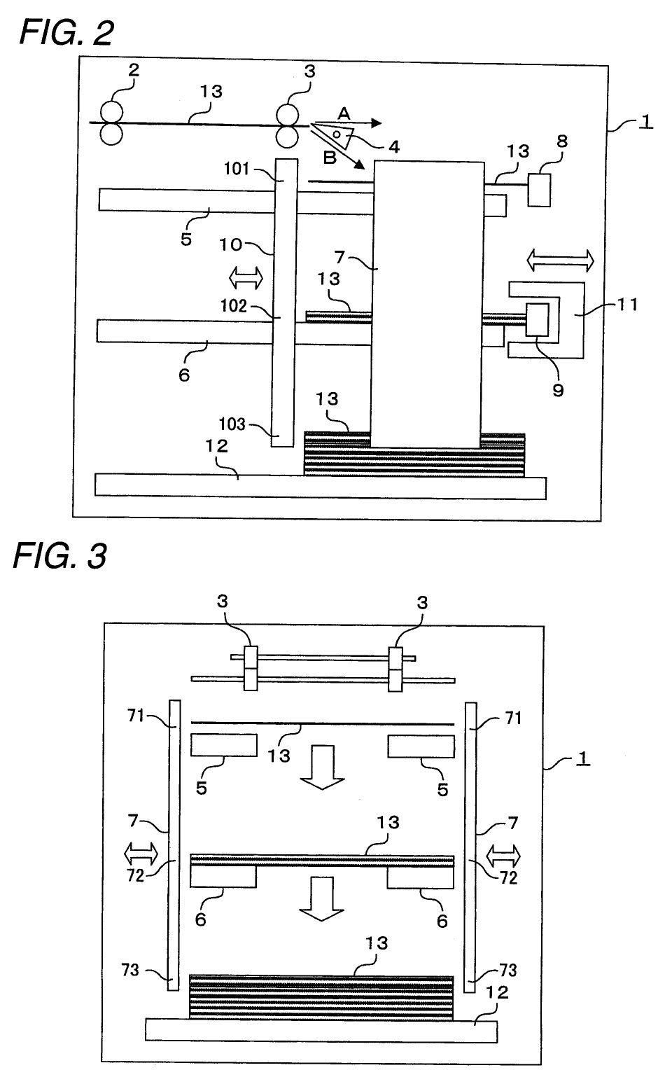

FIG. 2 is a schematic front view showing an example of the configuration of a post-processing apparatus of the exemplary embodiment of the invention, and FIG. 3 is a schematic view of the apparatus. The post-processing apparatus 1 is connected to the above-described image forming apparatus main unit 30. The illustrated post-processing apparatus 1 comprises sheet conveying rolls 2, 3, a gate 4, a pair of buffer arms 5, a pair of compile arms 6, a pair of side tampers 7, lead stoppers 8, 9, a tail tamper 10, a stapler 11, and a stack tray 12.

The sheet conveying rolls 2, 3 receive and conveys a sheet 13 on which an image has been formed, and which is discharged from the image forming apparatus main unit by, for example, the center registration method. In the center registration method, sheets of various sizes are conveyed while setting the center position in the sheet width direction as a common reference position, irrespective of the sizes of the sheets. In the side registration method, by contrast, sheets of various sizes are conveyed while setting one end portion (side end) in the sheet width direction as a common reference position. The sheet conveying method may be either of the center registration method and the side registration method. The exemplary embodiment will be described while assuming that the center registration method is employed. In each of the sheet conveying rolls 2, 3, the sheet 13 is nipped between a roll pair in which one roll is used a driving roll and the other roll is used as a driven roll, and then the sheet conveying roll rotates to give a conveying force to the sheet 13. The sheet conveying rolls 2 are placed on the upstream side of the sheet conveying roll 3 in the sheet conveying direction.

The gate 4 switches over the conveying direction in which the sheet is conveyed by the sheet conveying rolls 2, 3. Specifically, the gate 4 switches over the conveying direction of the sheet 13 which is fed by the sheet conveying roll 3. The gate 4 switches the sheet conveying direction to an obliquely downward direction (the direction of the arrow B in FIG. 2) in order to guide the sheet to the pair of buffer arms 5, and, as required, the gate 4 switches the sheet conveying direction to the horizontal direction (the direction of the arrow A in FIG. 2) in order to guide the sheet to another post-processing apparatus which is not shown.

Although only one gate 4 is shown in FIG. 2, actually, plural gates are disposed at different positions in the conveying direction in accordance with various sheet sizes (lengths). Then, a sheet is guided to the pair of buffer arms 5 by a gate which is disposed at a position corresponding to the size of the sheet.

In this way, the sheet 13 which is guided by the gate 4 to the pair of buffer arms 5 is sent to a lower portion of the post-processing apparatus 1 in the form that the sheet is vertically dropped in a sequence from a first stage to a second stage, and from the second stage to a third stage. In the vertical direction, the first stage is the uppermost stage. The sheet 13 is temporarily stored in the first stage, a bundle of sheets 13 is post-processed in the second stage, and the sheets 13 are stacked in the third stage.

Between the first and second stages, a space which is sufficient for supporting the sheets 13 in the stages in a completely separated manner is ensured. Also between the second and third stages, a space which is sufficient for supporting the sheets 13 in the stages in a completely separated manner is ensured. The sheet 13 which is supported in the second stage is positioned immediately below that which is supported in the first stage, and the sheet 13 which is supported in the third stage is positioned immediately below that which is supported in the second stage.

In the post-processing apparatus 1 having the three-stage structure, the pair of buffer arms 5 and the lead stopper 8 are disposed in the first stage, the pair of compile arms 6, the lead stopper 9, and the stapler 11 are disposed in the second stage, and the stack tray 12 is disposed in the third stage.

The pair of buffer arms 5 are disposed as a first supporting member in the first stage in the vertical direction. The pair of buffer arms 5 are opened and closed between a closed position where the gap of the arms is narrower than the width of the sheet 13, and an opened position where the gap of the arms is wider than the width of the sheet 13. The pair of buffer arms 5 are horizontally placed. When the pair of buffer arms 5 are moved to the closed position, therefore, the sheet 13 is horizontally supported in the form that the sheet is placed on the pair of buffer arms 5. At the closed position, consequently, the pair of buffer arms 5 horizontally support the sheet 13, and, at the opened position, are disengaged from the support of the sheet 13.

The lead stopper 8 restricts the lead end position of the sheet 13 supported by the pair of buffer arms 5. Here, the lead and position of a sheet means an end of the sheet which is placed while being directed toward the downstream side in the sheet conveying direction, and the rear end of a sheet means an end of the sheet which is placed while being directed toward the upstream side in the sheet conveying direction. A side end of a sheet means an end of the sheet which is placed while being directed in a direction which is parallel to the sheet conveying surface and perpendicular to the sheet conveying direction.

The pair of compile arms 6 are disposed as a second supporting member in the second stage in the vertical direction. In a similar manner as the pair of buffer arms 5, the pair of compile arms 6 are opened and closed between a closed position where the gap of the arms is narrower than the width of the sheet 13, and an opened position where the gap of the arms is wider than the width of the sheet 13. The pair of compile arms 6 are horizontally placed. At the closed position, consequently, also the pair of compile arms 6 horizontally support the sheet 13, and, at the opened position, are disengaged from the support of the sheet 13.

The lead stopper 9 restricts the lead end position of the sheet 13 supported by the pair of compile arms 6.

The stapler 11 is disposed as a post-processing unit in the second stage in the vertical direction. The stapler 11 performs a stapling process in which staples are driven into a bundle of sheets 13 supported by the pair of compile arms 6, thereby binding the bundle of the sheets 13. The stapler 11 is reciprocally moved in directions in which the stapler approaches and separates from the sheets 13 supported by the pair of compile arms 6. When the sheet 13 dropped from the pair of buffer arms 5 is to be received by the pair of compile arms 6, the stapler 11 is moved (retracted) in the direction in which the stapler separates from the sheet 13 so that the dropped sheet 13 is not contacted with the stapler 11, and, when the sheets 13 supported by the pair of compile arms 6 are to be stapled, the stapler 11 is moved (advanced) in the direction in which the stapler approaches the sheets 13 so that a bundle of the sheets 13 to be stapled is clamped by the stapler 11. As a post-processing unit, a unit which performs a boring process of forming bind holes in the bundle of the sheets 13, or that which performs another post process may be employed.

The stack tray 12 is disposed as a sheet stacking member in the third stage in the vertical direction. The stack tray 12 is used for stacking the bundle of the sheets 13 which have undergone the stapling process. The stack tray 12 is raised or lowered in accordance with driving of a lifting mechanism which is not shown. The level position of the stack tray 12 is controlled so that the position in the vertical direction where the tray receives sheets from the pair of compile arms 6 (hereinafter, the position is often referred to as “sheet receiving position”) is unchanged even when the stack amount (stack height) of sheets is increased. For example, the position is controlled so that, in a state where no sheets are stacked on the stack tray 12, the stack tray 12 waits at an initial position, and, in a state where sheets are stacked on the stack tray 12, the stack tray 12 is gradually lowered from the initial position in accordance with increase of the stack amount of sheets.

The pair of side tampers 7 are disposed as a sheet-side-end aligning member which aligns the side ends of sheets. The pair of side tampers 7 are opened and closed in the same directions as the above-described pairs of buffer arms 5 and compile arms 6. The pair of side tampers 7 are opened and closed between an opened position where the gap of the tampers is wider than the width of the sheet 13, and a closed position where the gap of the tampers is narrower than the width of the sheet 13. The side tampers have a function of aligning one sheet of one bundle with a predetermined position, and also a function of, with respect to the second and subsequent sheets which are continuously conveyed, repeating the operation of aligning a sheet with the predetermined position, whereby the side ends of all sheets constituting the bundle are aligned and collated with the same position. The side tampers have a further function of simultaneously aligning sheets on the first supporting member and the second supporting member. In this case, the side tampers have a function of simultaneously aligning sheets on the first and second supporting members even in the case where the number of the sheets on the first supporting member is different from that of the sheets on the second supporting member.

Each of the side tampers 7 has a plate-like shape which is vertically elongated. Each of the side tampers 7 integrally has: a portion (hereinafter, referred to as “first side-end butting portion”) 71 which butts against side ends of the sheet 13 supported by the pair of buffer arms 5 in the first stage in the vertical direction; a portion (hereinafter, referred to as “second side-end butting portion”) 72 which butts against side ends of the sheets 13 supported by the pair of compile arms 6 in the second stage in the vertical direction; and a portion (hereinafter, referred to as “third side-end butting portion”) 73 which butts against side ends of the sheets 13 stacked on the stack tray 12 in the third stage in the vertical direction.

The first side-end butting portion 71 is placed at the same level position as the sheet 13 supported by the pair of buffer arms 5. The second side-end butting portion 72 is placed at the same level position as the sheets 13 supported by the pair of compile arms 6. The third side-end butting portion 73 is placed at the same level position as the sheet 13 which is one of the sheets 13 stacked on the stack tray 12, and which is stacked at the sheet receiving position. The side tamper 7 may be configured so that the length of the tamper is reduced and the first and second side-end butting portions 71, 72 are integrated with each other except the third side-end butting portion 73.

The tail tamper 10 is disposed as a sheet-rear-end aligning member which aligns rear ends of sheets. The tail tamper 10 is reciprocally moved in the sheet length directions (directions in which the tail tamper approaches and separates from the rear end of the sheet 13) which extend along the sheet conveying direction. The tail tamper 10 has a plate-like shape which is vertically elongated. The tail tamper 10 integrally has: a portion (hereinafter, referred to as “first rear-end butting portion”) 101 which butts against the rear end of the sheet 13 supported by the pair of buffer arms 5 in the first stage in the vertical direction; a portion (hereinafter, referred to as “second rear-end butting portion”) 102 which butts against the rear ends of the sheets 13 supported by the pair of compile arms 6 in the second stage in the vertical direction; and a portion (hereinafter, referred to as “third rear-end butting portion”) 103 which butts against the rear ends of the sheets 13 stacked on the stack tray 12 in the third stage in the vertical direction.

The first rear-end butting portion 101 is placed at the same level position as the sheet 13 supported by the pair of buffer arms 5. The second rear-end butting portion 102 is placed at the same level position as the sheets 13 supported by the pair of compile arms 6. The third rear-end butting portion 103 is placed at the same level position as the sheet 13 which is one of the sheets 13 stacked on the stack tray 12, and which is stacked at the sheet receiving position. The tale tamper 10 may be configured so that the length of the tamper is reduced and the first and second rear-end butting portions 101, 102 are integrated with each other except the third rear-end butting portion 103.

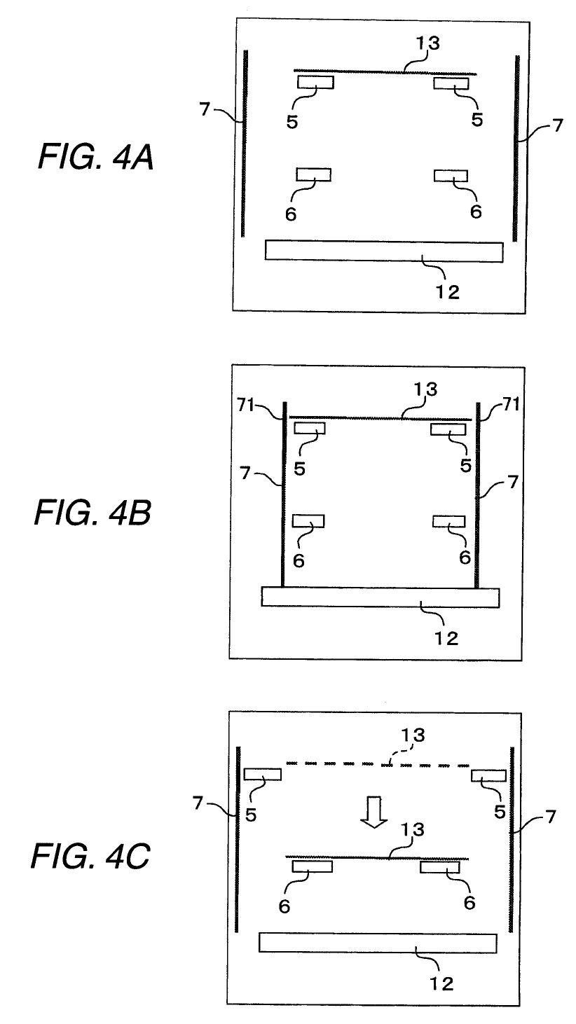

Then, the operation of the thus configured post-processing apparatus 1 will be described with reference to FIGS. 4 to 10. The case where two sheets are processed as one bundle will be exemplarily described. However, the number of sheets which are processed in one operation can be arbitrarily changed.

Among sheets which are conveyed by the sheet conveying rolls 2, 3, first, the sheet 13 having a certain size is guided obliquely downwardly by the gate 4. In advance of feeding of the sheet 13, as shown in FIG. 4A, both the pairs of buffer and compile arms 5, 6 wait at the respective closed positions, and the pair of side tampers 7 wait at the opened position. Therefore, the sheet 13 which is guided obliquely downwardly by the gate 4 is in a state where it is placed on the pair of buffer arms 5, and horizontally supported by the pair of buffer arms 5.

As shown in FIG. 4B, next, the pair of side tampers 7 are moved (close-operated) from the opened position to the closed position. This causes the first side-end butting portions 71 of the side tampers 7 to butt against side ends of the sheet 13 from the lateral sides. Therefore, the side-end positions of the sheet 13 are aligned on the pair of buffer arms 5 which constitute the first stage. In this step, the tail tamper 10 is reciprocally moved in the sheet length directions, so that the first rear-end butting portion 101 of the tail tamper 10 butts against the rear end of the sheet 13. Therefore, the sheet 13 which is supported by the pair of buffer arms 5 is in a state where it is interposed between the lead stopper 8 and the tail tamper 10. Consequently, the rear end of the sheet 13 in the first stage is aligned. In this step, no sheet exists on the compile arms. In view of the productivity, therefore, the tamping of a sheet on the buffer arms may be skipped.

As shown in FIG. 4C, then, the pair of side tampers 7 are moved (open-operated) from the closed position to the opened position, and the pair of buffer arms 5 are moved (open-operated) from the closed position to the opened position. This causes the support of the sheet 13 by the pair of buffer arms 5 to be cancelled. Therefore, the sheet 13 in the first stage is dropped onto the pair of compile arms 6.

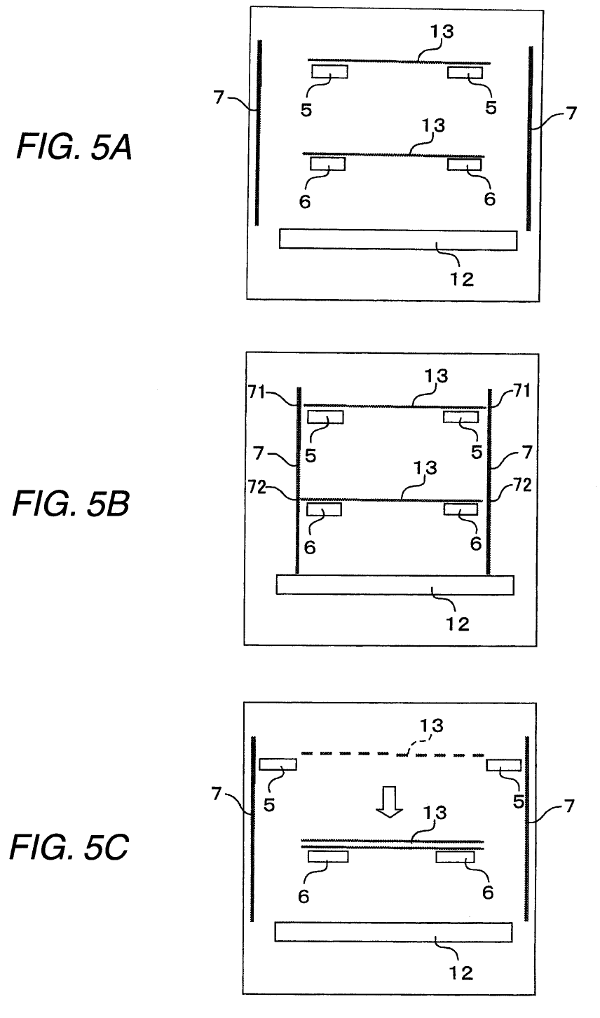

As shown in FIG. 5A, then, the pair of buffer arms 5 are moved from the opened position to the closed position, and, in this state, the next sheet 13 is fed onto the pair of buffer arms 5 by the gate 4.

As shown in FIG. 5B, then, the pair of side tampers 7 are moved from the opened position to the closed position. This causes the first side-end butting portions 71 of the side tampers 7 to butt against side ends of the sheet 13 supported by the pair of buffer arms 5, and the second side-end butting portions 72 of the pair of side tampers 7 to butt against side ends of the sheet 13 supported by the pair of compile arms 6. Therefore, the side-end positions of the sheets 13 are simultaneously aligned in the first and second stages. In this step, the tail tamper 10 is reciprocally moved in the sheet length directions, so that the first rear-end butting portion 101 of the tail tamper 10 butts against the rear end of the sheet 13 supported by the pair of buffer arms 5, and the second rear-end butting portion 102 of the tail tamper 10 butts against the rear end of the sheet 13 supported by the pair of compile arms 6. Therefore, the rear-end positions of the sheets 13 are simultaneously aligned in the first and second stages.

As shown in FIG. 5C, then, the pair of side tampers 7 are moved from the closed position to the opened position, and the pair of buffer arms 5 are moved from the closed position to the opened position. Therefore, the sheet 13 in the first stage is dropped onto the sheet 13 supported by the pair of compile arms 6.

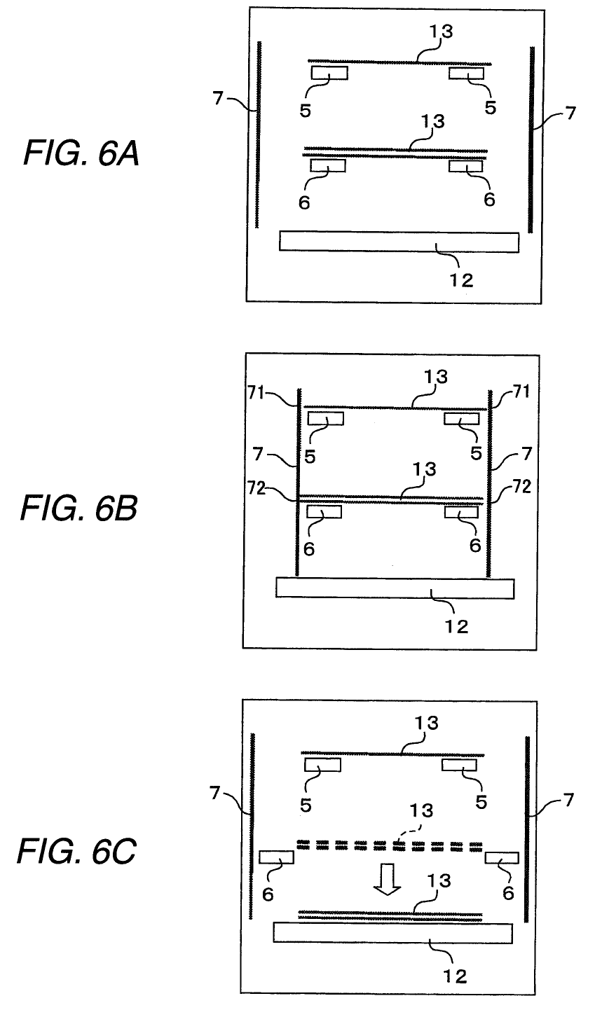

As shown in FIG. 6A, then, the pair of buffer arms 5 are moved from the opened position to the closed position, and, in this state, the next sheet 13 is fed onto the pair of buffer arms 5 by the gate 4.

As shown in FIG. 6B, then, the pair of side tampers 7 are moved from the opened position to the closed position. This causes the first side-end butting portions 71 of the side tampers 7 to butt against side ends of the sheet 13 supported by the pair of buffer arms 5, and the second side-end butting portions 72 of the pair of side tampers 7 to butt against side ends of the sheet 13 supported by the pair of compile arms 6. Therefore, the side-end positions of the sheets 13 are simultaneously aligned in the first and second stages. In this step, the tail tamper 10 is reciprocally moved in the sheet length directions, so that the first rear-end butting portion 101 of the tail tamper 10 butts against the rear end of the sheet 13 supported by the pair of buffer arms 5, and the second rear-end butting portion 102 of the tail tamper 10 butts against the rear end of the sheet 13 supported by the pair of compile arms 6. Consequently, the rear-end positions of the sheets 13 are simultaneously aligned in the first and second stages. In the state where the positions of the side and rear ends of the sheets 13 are aligned in this way, the stapler 11 is operated, so that the stapling process is performed on the bundle of the sheets 13 supported by the pair of compile arms 6.

As shown in FIG. 6C, then, the pair of side tampers 7 are moved from the closed position to the opened position, and the pair of compile arms 6 are moved from the closed position to the opened position. Therefore, the sheets 13 in the second stage are dropped onto the stack tray 12.

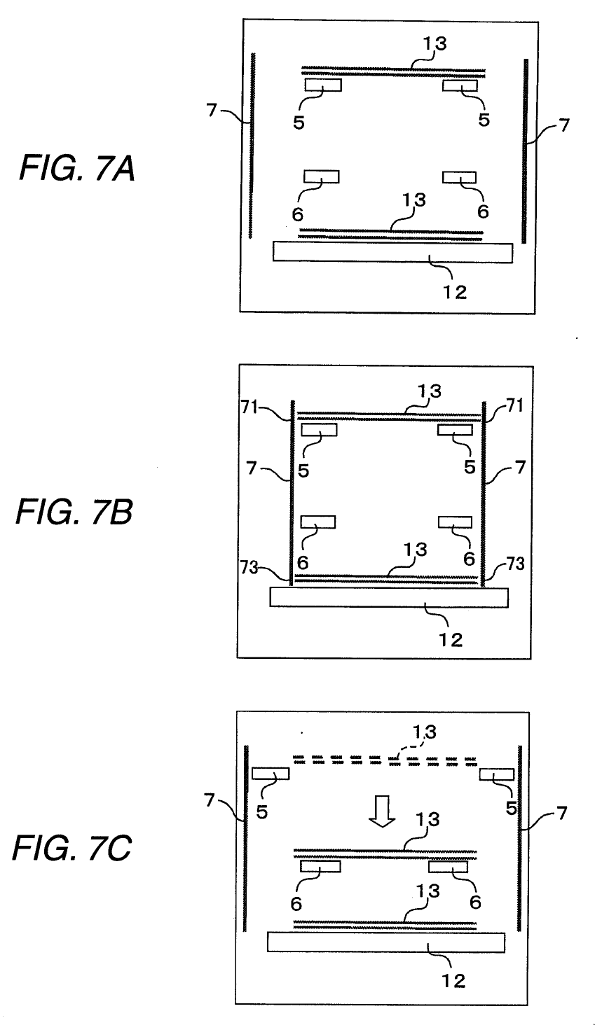

As shown in FIG. 7A, then, the pair of compile arms 6 are moved from the opened position to the closed position. The next sheet 13 which is fed by the gate 4 is overlapped on the sheet 13 which is previously supported by the pair of buffer arms 5.

As shown in FIG. 7B, then, the pair of side tampers 7 are moved from the opened position to the closed position. This causes the first side-end butting portions 71 of the side tampers 7 to butt against side ends of the sheets 13 supported by the pair of buffer arms 5, and the third side-end butting portions 73 of the pair of side tampers 7 to butt against side ends of the sheets 13 stacked on the stack tray 12. Therefore, the side-end positions of the sheets 13 are simultaneously aligned in the first and third stages. In this step, the tail tamper 10 is reciprocally moved in the sheet length directions, so that the first rear-end butting portion 101 of the tail tamper 10 butts against the rear ends of the sheets 13 supported by the pair of buffer arms 5, and the third rear-end butting portion 103 of the tail tamper 10 butts against the rear ends of the sheets 13 stacked on the stack tray 12. Consequently, the rear-end positions of the sheets 13 are simultaneously aligned in the first and third stages. In this step, no sheet exists on the compile arms. In view of the productivity, therefore, the tamping of sheets on the buffer arms may be skipped.

As shown in FIG. 7C, then, the pair of side tampers 7 are moved from the closed position to the opened position, and the pair of buffer arms 5 are moved from the closed position to the opened position. Therefore, the sheets 13 in the first stage are dropped onto the pair of compile arms 6.

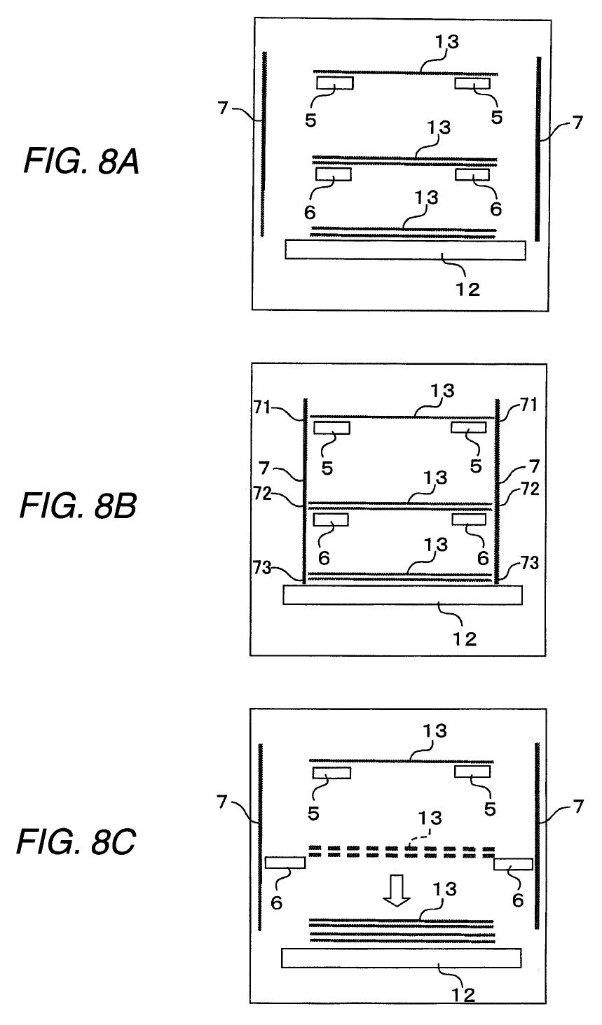

As shown in FIG. 8A, then, the pair of buffer arms 5 are moved from the opened position to the closed position, and, in this state, the next sheet 13 is fed onto the pair of buffer arms 5 by the gate 4. In this step, the sheets 13 are supported respectively by the first, second, and third stages.

As shown in FIG. 8B, then, the pair of side tampers 7 are moved from the opened position to the closed position. This causes the first side-end butting portions 71 of the side tampers 7 to butt against side ends of the sheet 13 supported by the pair of buffer arms 5, the second side-end butting portions 72 of the pair of side tampers 7 to butt against side ends of the sheets 13 supported by the pair of compile arms 6, and the third side-end butting portions 73 of the pair of side tampers 7 to butt against side ends of the sheets 13 stacked on the stack tray 12. Therefore, the side-end positions of the sheets 13 are simultaneously aligned in the first, second, and third stages. In this step, the tail tamper 10 is reciprocally moved in the sheet length directions, so that the first rear-end butting portion 101 of the tail tamper 10 butts against the rear ends of the sheets 13 supported by the pair of buffer arms 5, the second rear-end butting portion 102 of the tail tamper 10 butts against the rear ends of the sheets 13 supported by the pair of compile arms 6, and the third rear-end butting portion 103 of the tail tamper 10 butts against the rear ends of the sheets 13 stacked on the stack tray 12. Consequently, the rear-end positions of the sheets 13 are simultaneously aligned in the first, second, and third stages. In the state where the positions of the side and rear ends of the sheets 13 are aligned in this way, the stapler 11 is operated, so that the stapling process is performed on the bundle of the sheets 13 supported by the pair of compile arms 6.

As shown in FIG. 8C, then, the pair of side tampers 7 are moved from the closed position to the opened position, and the pair of compile arms 6 are moved from the closed position to the opened position. Therefore, the sheets 13 in the second stage are dropped onto the stack tray 12, and the stack tray 12 is lowered in accordance with the stack height of the sheets 13.

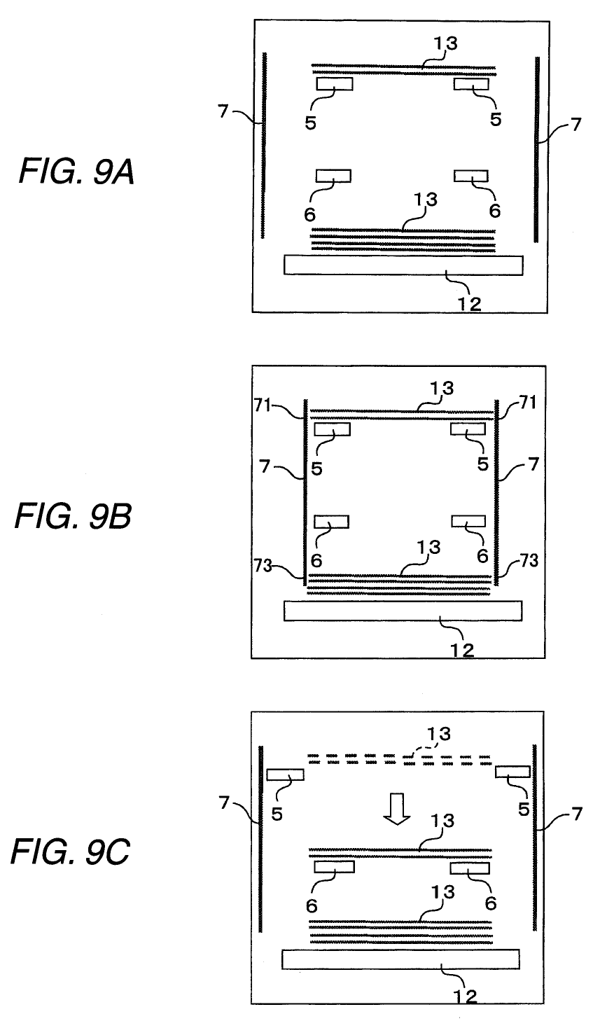

As shown in FIG. 9A, then, the pair of compile arms 6 are moved from the opened position to the closed position. The next sheet 13 which is fed by the gate 4 is overlapped on the sheet 13 which is previously supported by the pair of buffer arms 5.

As shown in FIG. 9B, then, the pair of side tampers 7 are moved from the opened position to the closed position. This causes the first side-end butting portions 71 of the side tampers 7 to butt against side ends of the sheets 13 supported by the pair of buffer arms 5, and the third side-end butting portions 73 of the pair of side tampers 7 to butt against side ends of the sheets 13 stacked on the stack tray 12. Therefore, the side-end positions of the sheets 13 are simultaneously aligned in the first and third stages. In this step, the tail tamper 10 is reciprocally moved in the sheet length directions, so that the first rear-end butting portion 101 of the tail tamper 10 butts against the rear ends of the sheets 13 supported by the pair of buffer arms 5, and the third rear-end butting portion 103 of the tail tamper 10 butts against the rear ends of the sheets 13 stacked on the stack tray 12. Consequently, the rear-end positions of the sheets 13 are simultaneously aligned in the first and third stages. In this step, no sheet exists on the compile arms. In view of the productivity, therefore, the tamping of sheets on the buffer arms may be skipped.

As shown in FIG. 9C, then, the pair of side tampers 7 are moved from the closed position to the opened position, and the pair of buffer arms 5 are moved from the closed position to the opened position. Therefore, the sheets 13 in the first stage are dropped onto the pair of compile arms 6.

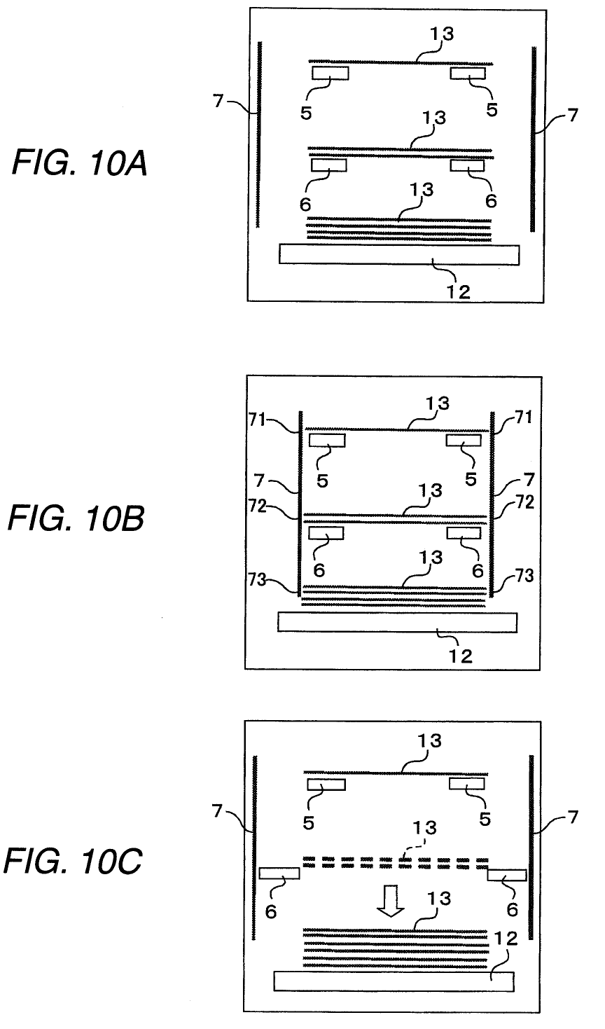

As shown in FIG. 10A, then, the pair of buffer arms 5 are moved from the opened position to the closed position, and, in this state, the next sheet 13 is fed onto the pair of buffer arms 5 by the gate 4. In this step, the sheets are supported respectively by the first, second, and third stages.

As shown in FIG. 10B, then, the pair of side tampers are moved from the opened position to the closed position. This causes the first side-end butting portions 71 of the side tampers 7 to butt against side ends of the sheet 13 supported by the pair of buffer arms 5, the second side-end butting portions 72 of the pair of side tampers 7 to butt against side ends of the sheets 13 supported by the pair of compile arms 6, and the third side-end butting portions 73 of the pair of side tampers 7 to butt against side ends of the sheets 13 stacked on the stack tray 12. Therefore, the side-end positions of the sheets 13 are simultaneously aligned in the first, second, and third stages. In this step, the tail tamper 10 is reciprocally moved in the sheet length directions, so that the first rear-end butting portion 101 of the tail tamper butts against the rear end of the sheet 13 supported by the pair of buffer arms 5, the second rear-end butting portion 102 of the tail tamper 10 butts against the rear ends of the sheets 13 supported by the pair of compile arms 6, and the third rear-end butting portion 103 of the tail tamper 10 butts against the rear ends of the sheets 13 stacked on the stack tray 12. Consequently, the rear-end positions of the sheets 13 are simultaneously aligned in the first, second, and third stages. In the state where the positions of the side and rear ends of the sheets 13 are aligned in this way, the stapler 11 is operated, so that the stapling process is performed on the bundle of the sheets 13 supported by the pair of compile arms 6.

As shown in FIG. 10C, then, the pair of side tampers 7 are moved from the closed position to the opened position, and the pair of compile arms 6 are moved from the closed position to the opened position. Therefore, the sheets 13 which are in the second stage, and which have undergone the stapling process are dropped onto the stack tray 12, and the stack tray 12 is lowered in accordance with the stack height of the sheets 13.

Thereafter, the procedures of FIG. 9A to FIG. 10C are performed until the last sheet 13 undergoes the stapling process on the pair of compile arms 6 and is stacked onto the stack tray 12.

In a post-processing apparatus 1 comprising a tale tamper 10 in which the third rear-end butting portion 103 is integrated in addition to the first and second rear-end butting portions 101, 102, in the case where sheets which are different in size from bundle to bundle are handled (the size mix stack is executed), or in the case where sheets are to be stacked while rear-end positions of the sheets are shifted from bundle to bundle (the offset stack is executed), it is preferable to inhibit the sheet aligning operation (the reciprocal moving operation) by the tail tamper 10 while the tail tamper 10 is retracted in the direction in which the tail tamper separates from the rear end of the sheet 13.

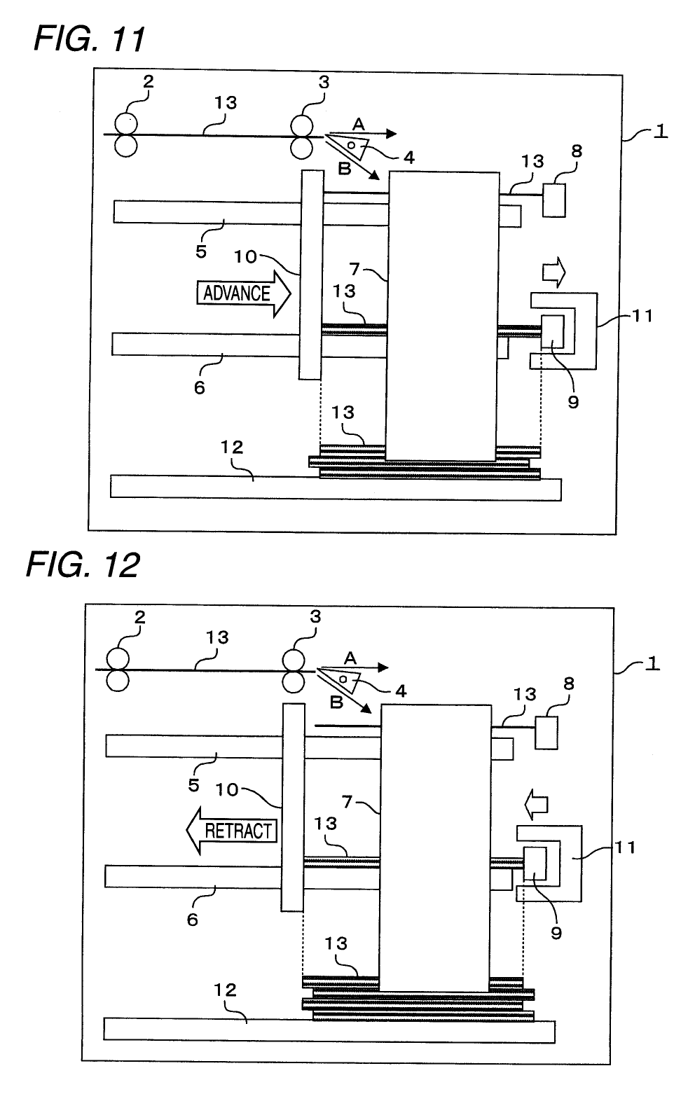

Alternatively, the tail tamper 10 may be configured in the following manner in order to cope with the offset stack of sheet bundles of the same size. As shown in FIGS. 11 and 12, for example, the third rear-end butting portion 103 is eliminated to reduce the length of the tail tamper 10, and the positions of the lead stopper 9, the tail tamper 10, and the stapler 11 are advanced or retracted from bundle to bundle, whereby sheets are stacked on the stack tray 12 while the rear-end positions are shifted.

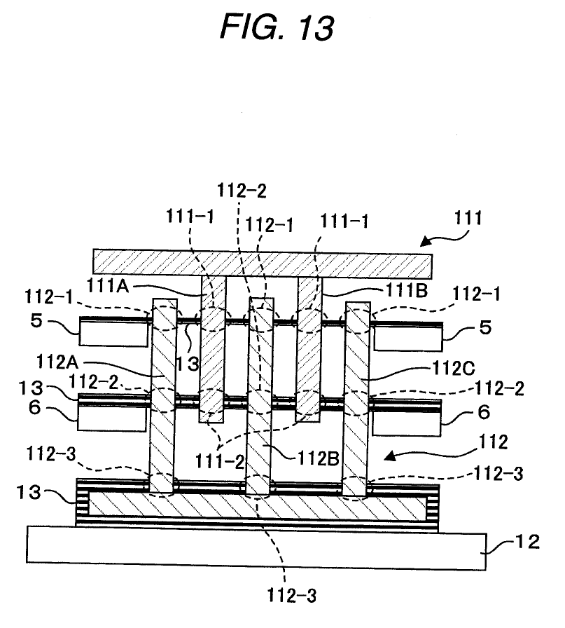

Alternatively, the tail tamper 10 may have a split structure shown in, for example, FIG. 13. Referring to FIG. 13, the tail tamper 10 has a two-split structure configured by: a first tale tamper 111 which is disposed as a first sheet-rear-end aligning member; and a second tale tamper 112 which is disposed as a second sheet-rear-end aligning member.

The first tale tamper 111 has two tamper arms 111A, 111B, and the second tale tamper 112 has three tamper arms 112A, 112B, 112C. The tamper arms are placed in the following manner in the direction (sheet width direction) perpendicular to the sheet conveying direction. In the two tamper arms 111A, 111B, specifically, one tamper arm 111A is placed between the tamper arms 112A, 112B, and the other tamper arm 111B is placed between the tamper arms 112B, 112C.

Each of the tamper arms 111A, 111B of the first tale tamper 111 integrally has: a portion (hereinafter, referred to as “first rear-end butting portion”) 111-1 which butts against the rear end of the sheet 13 supported by the pair of buffer arms 5 in the first stage in the vertical direction; and a portion (hereinafter, referred to as “second rear-end butting portion”) 111-2 which butts against the rear ends of the sheets 13 supported by the pair of compile arms 6 in the second stage in the vertical direction.

Each of the tamper arms 112A, 112B, 112C of the second tale tamper 112 integrally has: a portion (hereinafter, referred to as “first rear-end butting portion”) 112-1 which butts against the rear end of the sheet 13 supported by the pair of buffer arms 5 in the first stage in the vertical direction; a portion (hereinafter, referred to as “second rear-end butting portion”) 112-2 which butts against the rear ends of the sheets 13 supported by the pair of compile arms 6 in the second stage in the vertical direction; and a portion (hereinafter, referred to as “third rear-end butting portion”) 112-3 which butts against the rear ends of the sheets 13 stacked on the stack tray 12 in the third stage in the vertical direction.

In the post-processing apparatus 1 comprising the tail tamper 10 having the split structure, in the case where the first tale tamper is reciprocally moved in state where the sheets 13 are placed respectively on the pair of buffer arms 5 which constitute as the first stage, the pair of compile arms 6 which constitute as the second stage, and the stack tray 12 which constitutes as the third stage, the first rear-end butting portions 111-1 of the tamper arms 111A, 111B butt against the rear end of the sheet 13 supported by the pair of buffer arms 5, and the second rear-end butting portions 111-2 of the tamper arms 111A, 111B butt against the rear ends of the sheets 13 supported by the pair of compile arms 6. Therefore, the rear-end positions of the sheets 13 are simultaneously aligned in the first and second stages.

In the case where the second tale tamper 112 is reciprocally moved in place of the first tale tamper 111, by contrast, the first rear-end butting portions 112-1 of the tamper arms 112A, 112B, 112C butt against the rear end of the sheet 13 supported by the pair of buffer arms 5, the second rear-end butting portions 112-2 of the tamper arms 112A, 112B, 112C butt against the rear ends of the sheets 13 supported by the pair of compile arms 6, and the third rear-end butting portions 112-3 of the tamper arms 112A, 112B, 112C butt against the rear ends of the sheets 13 stacked on the stack tray 12. Therefore, the rear-end positions of the sheets 13 are simultaneously aligned in the first, second, and third stages.

In the thus configured post-processing apparatus 1, in the case where sheets which are different in size from bundle to bundle are handled (the size mix stack is executed), or in the case where sheets are to be stacked while rear-end positions of the sheets are shifted from bundle to bundle (the case where the sheet widths in the side-tamping direction are equal to one another, such as the case where the offset stack is executed, or that where A4 LEF is stacked on A3 SEF), the sheets are aligned by operating (reciprocally moving) the first tale tamper 111 while the second tale tamper 112 is retracted in the direction in which the tail tamper separates from the rear ends of the sheets 13. In the case where sheets which have the same size from bundle to bundle are to be stacked while rear-end positions of the sheets are aligned (the case where usual stacking is to be executed), the sheets are aligned by operating (reciprocally moving) the second tale tamper 112 while the first tale tamper 111 is retracted in the direction in which the tail tamper separates from the rear ends of the sheets 13. The operation of the first tale tamper 111, and that of the second tale tamper 112 may be switched over by a controlling unit which is not shown, depending on the process conditions (the offset stack is to be executed or not, and the side mix stack is to be executed or not) at the operation.

The post-processing apparatus of the invention may be combined with an image forming apparatus main unit (not shown) comprising a printer engine for forming an image on a sheet, and the like, to constitute a part of an image forming apparatus such as a digital copier or a digital multifunction machine. Therefore, the invention may be realized as an image forming apparatus including the post-processing apparatus 1 having the above-described configuration.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. A post-processing apparatus in which a sheet to be post-processed is substantially vertically dropped in a sequence from a first stage to a second stage, and from the second stage to a third stage, the sheet is temporarily stored in the first stage, a bundle of sheets is post-processed in the second stage, and the sheets are stacked in the third stage, wherein
an opening/closing first supporting member that, at a closed position, substantially horizontally supports a sheet, and that, at an opened position, is disengaged from the support of the sheet is disposed in the first stage,
an opening/closing second supporting member that, at a closed opened position, substantially horizontally supports a sheet, and that, at an opened position, is disengaged from the support of the sheet, and a post-processing unit that post-processes a bundle of sheets supported by the second supporting member are disposed in the second stage,
a sheet stacking member on which the bundle of sheets that has been subjected to the post-processing is stacked is disposed in the third stage, and
the apparatus comprises
an integral sheet aligning member that butts against an end portion of the sheet supported by the first supporting member, and end portions of the sheets supported by the second supporting member, and
a sheet aligning member moving unit that moves the sheet aligning member.

2. The post-processing apparatus according to claim 1, wherein the sheet aligning member integrally has a portion that butts against end portions of the sheets stacked on the sheet stacking member.

3. The post-processing apparatus according to claim 1, wherein the sheet aligning member is a sheet-side-end aligning member that aligns side ends of the sheets.

4. The post-processing apparatus according to claim 1, wherein the sheet aligning member is a sheet-rear-end aligning member that aligns rear ends of the sheets.

5. The post-processing apparatus according to claim 4, wherein the sheet-rear-end aligning member comprises:
a first sheet-rear-end aligning member that integrally has a portion that butts against a rear end of a sheet supported by the first supporting member, and a portion that butts against a rear end of a sheet supported by the second supporting member; and
a second sheet-rear-end aligning member that integrally has a portion that butts against the rear end of the sheet supported by the first supporting member, a portion that butts against the rear end of the sheet supported by the second supporting member, and a portion that butts against rear ends of sheets stacked on the sheet stacking member,
in a case where sheets which are different in size from bundle to bundle are handled, or in a case where sheets are to be stacked while rear-end positions of the sheets are shifted from bundle to bundle, the sheets are aligned by operating the first sheet-rear-end aligning member, and, in a case where sheets which has a same size from bundle to bundle are to be stacked while rear-end positions of the sheets are aligned, the sheets are aligned by operating the second sheet-rear-end aligning member.

6. The post-processing apparatus according to claim 4, wherein, in a case where sheets which are different in size from bundle to bundle are handled, or in a case where sheets are to be stacked while rear-end positions of the sheets are shifted from bundle to bundle, a sheet aligning operation of the sheet-rear-end aligning member is inhibited.

7. An image forming apparatus comprising
an image forming portion that forms an image on a sheet, and
a post-processing apparatus that post-processes the sheet on which an image is formed by the image forming portion, wherein,
in the post-processing apparatus, a sheet to be post-processed is substantially vertically dropped in a sequence from a first stage to a second stage, and from the second stage to a third stage, the sheet is temporarily stored in the first stage, a bundle of sheets is post-processed in the second stage, and the sheets are stacked in the third stage,
an opening/closing first supporting member that, at a closed opened position, substantially horizontally supports a sheet, and that, at an opened position, is disengaged from the support of the sheet is disposed in the first stage,
an opening/closing second supporting member that, at a closed opened position, substantially horizontally supports a sheet, and that, at an opened position, is disengaged from the support of the sheet, and a post-processing unit that post-processes a bundle of sheets supported by the second supporting member are disposed in the second stage,
a sheet stacking member on which the bundle of sheets that has been subjected to the post-processing is stacked is disposed in the third stage, and
the post-processing apparatus comprises
an integral sheet aligning member that butts against an end portion of the sheet supported by the first supporting member, and end portions of the sheets supported by the second supporting member, and
a sheet aligning member moving unit that moves the sheet aligning member.
